(19) United States
(12) Patent Application Publication
(10) Pub. No.: US 2026/0138169 A1
(43) Pub. Date: May 21, 2026

(54) EXTRUSION PRESS FOR PRODUCING METAL PRODUCTS

(71) Applicant: DANIELI & C. OFFICINE MECCANICHE S.P.A., Buttrio (IT)

(72) Inventors: Alessandro Mario GALLI, Buttrio (IT); Giacomo CALVETTI, Buttrio (IT); Mattia MERLINI, Buttrio (IT)

(21) Appl. No.: 19/122,996

(22) PCT Filed: Nov. 2, 2023
(86) PCT No.: PCT/IB2023/061028

§ 371 Date: Apr. 21, 2025

(30) Foreign Application Priority Data
Nov. 2, 2022 (IT) 102022000022446

(51) Int. Cl. B21C 23/21; B21C 35/04

(52) U.S. Cl. CPC B21C 23/212; B21C 35/04

(57) ABSTRACT

An extrusion press for producing a metal extrudate by extruding a billet along an extrusion axis in an extrusion direction. The extrusion press comprises: a die holder cassette; a die stack accommodated at least partially in the die holder cassette, in particular wherein the die stack comprises an extrusion die; thrust means adapted to move the die stack parallel to the extrusion axis in direction opposite to the extrusion direction; a body arranged between the thrust means and the die stack, provided with a through hole which allows the passage of the metal extrudate through it; a crosspiece arranged downstream of the die stack; and a pressure ring accommodated at least partially in the crosspiece; wherein said body is distinct from the pressure ring; wherein said body and the die stack are adapted to translate along the extrusion axis with respect to the die holder cassette; and wherein the thrust means are adapted to push said body to translate it, and said body is adapted to push the die stack, transmitting the translation motion imparted by the thrust means to the die stack to translate it parallel to the extrusion axis in said direction opposite to the extrusion direction.

### CROSS-REFERENCE TO RELATED APPLICATIONS

This application claims priority to PCT International Application No. PCT/IB2023/061028 filed on Nov. 2, 2023, which claims priority to Italian Patent Application No. 102022000022446 filed on Nov. 2, 2022, the entire disclosures of which are expressly incorporated herein by reference.

### STATEMENT RE: FEDERALLY SPONSORED RESEARCH/DEVELOPMENT

Not Applicable

### BACKGROUND

### 1. Field of the Invention

The present invention relates to the field of extrusion presses for producing metal products by extruding a billet.

In particular, the invention relates to an extrusion press for producing products, or extrudates, made of non-ferrous metal, for example, aluminum or aluminum alloy.

### 2. Background Art

An extrusion press for non-ferrous metals, such as aluminum or aluminum alloy, typically comprises a punch adapted to push a billet to be extruded through a die stack, which comprises an extrusion die. The die stack is contained in a die holder cassette, which faces an extrusion crosspiece. There is a pressure ring in the extrusion crosspiece. One of the functions of the pressure ring is to distribute the extrusion force to the crosspiece.

At the end of each extrusion operation, the non-extruded material which remains attached to the die stack is removed by means of a shear arranged above the press. This cutting is performed at the end of each extrusion cycle, prior to loading a new billet to be extruded into the press.

The elimination of the non-extruded material is very important because oxides and slag accumulate in this portion of material.

The face of the die stack and the shear blade must be perfectly aligned with each other to ensure the best cutting and the perfect cleaning of the die.

If the blade is too far from the die stack, the residual material may accumulate over time on the face of the die stack and may affect the quality of the extruded product.

If the blade is too close to the die stack, the blade may remove material also from inside the die stack, creating undesired air bubbles called blisters in the extruded product, and also, excessive blade wear is generated.

The best cutting results are achieved when the shear blade is at a distance of 0.1 to 0.3 mm from the face of the die stack.

The die stack has a preset length. The die stack is replaced according to the type of extrudate profile which is to be produced. Typically, the die stack is changed from 5 to 20 times a day. Although the length of the die stack is preset, the actual size thereof may vary with respect to the theoretical size due to the processing tolerances of the die stack. Further, the die stack is subject to considerable temperature ranges during operation, which cause the length thereof to vary.

Due to the considerable variability of the dimensions of the die stack, an auxiliary system for compensating for this variation is required to ensure correct cutting.

A first system for ensuring the alignment between the die stack and the shear blade provides moving the entire shear to position it in line with the face of the die stack.

A second system, alternative to the first one, for ensuring the alignment between the die stack and the shear blade provides pushing the die stack against an abutment surface, which is fixed in position, so that when the die stack is pushed against the abutment surface, the die stack and the shear are always aligned with each other.

To make this system, there are cylinders in the press which push the pressure ring against the die stack. An abutment surface which stops the die stack in the correct position is provided.

Since the abutment surface is close to the face of the die stack, the variations due to the processing or the thermal expansions are minimum and the position of the face of the die stack is always within a good cutting tolerance.

This second system has disadvantages. In particular, since the pressure ring is used to push the die stack against the abutment surface, the pressure ring is particularly subject to wear. The pressure ring is rather difficult to replace, in particular because it is accommodated in the extrusion crosspiece. Further, dirt may accumulate between the pressure ring and the extrusion crosspiece. Further, restoring the pressure ring guiding bands disadvantageously is required in this second system.

Therefore, the need is felt to improve the alignment system between shear and die stack.

### BRIEF SUMMARY

It is an object of the present invention to provide an extrusion press for producing a metal extrudate, in particular made of aluminum or aluminum alloy, requiring less maintenance and in which maintenance operations may be performed more easily.

A particular object of the present invention is to minimize the wear of the die stack.

A particular object of the present invention is to minimize the wear of the pressure ring.

A particular object of the present invention is to minimize the accumulation of dirt between the pressure ring and the extrusion crosspiece.

The present invention achieves at least one of such objects and other objects that will become apparent in light of the present description, by means of an extrusion press for producing a metal extrudate by extruding a billet along an extrusion axis in an extrusion direction, the extrusion press comprising:
a die holder cassette;
a die stack accommodated at least partially in the die holder cassette, in particular wherein the die stack comprises an extrusion die;
thrust means adapted to move the die stack parallel to the extrusion axis in opposite direction to the extrusion direction;
a body arranged between the thrust means and the die stack, provided with a through hole that allows the passage of the metal extrudate through it;
a crosspiece arranged downstream of the die stack, in particular downstream with respect to the extrusion direction;
a pressure ring accommodated at least partially in the crosspiece;
   wherein said body is distinct from the pressure ring;
   wherein said body and said die stack are adapted to translate along the extrusion axis with respect to the die holder cassette;
   wherein the thrust means are adapted to push said body to translate it, and said body is adapted to push the die stack, transmitting the translation motion imparted by the thrust means to the die stack to translate it parallel to the extrusion axis in said direction opposite to the extrusion direction.

The invention also relates to an extrusion apparatus, in particular according to claim 13.

The invention also relates to a method for removing possible residues of material from the die stack, in particular according to claim 14.

Advantageously, according to the invention, the aforesaid body is provided (in particular, additional with respect to the aforesaid second system), which is interposed between the die stack and the pressure ring. Therefore, the thrust means do not move the pressure ring, which in particular remains stationary, rather they move the aforesaid body, which in turn pushes the die stack, in particular against an abutment surface which is preferably provided in the die holder cassette.

Advantageously, the aforesaid body is distinct from the die stack. Advantageously, the die stack may be replaced with another die stack, leaving the aforesaid body mounted in the extrusion press.

Advantageously, the thrust means do not act directly on the die stack, in particular they do not act directly on a bolster of the die stack, rather they act on the aforesaid body or thrust body. Thus, the wear of the die stack is minimized. In particular, the die stack advantageously is not subjected to concentrated loads, localized on small portions of surface.

Preferably, in all the embodiments at least part of the periphery of said body is arranged in a groove of the inner surface of the die holder cassette. This feature is particularly useful for ensuring the aforesaid body remains in position when the die stack is replaced. Therefore, the replacement of the die stack is particularly easy.

Some advantages of an extrusion press according to the invention are:
the wear of the die stack is minimized;
the position of the cutting means along the extrusion axis remains fixed;
the pressure ring is not moved to push the die stack, and therefore does not wear out;
the pressure ring guiding bands do not require restoring; in particular, advantageously there are no pressure ring guiding bands in a press according to the invention;
the maintenance of the aforesaid body is easy and further, the aforesaid body may be easily replaced, in particular when said body is accommodated at least partially in the die holder cassette;
dirt is not accumulated between the pressure ring and the extrusion crosspiece.

Further features and advantages of the invention will be more apparent in light of the detailed description of exemplary, but non-exclusive embodiments.

The dependent claims describe particular embodiments of the invention.

### BRIEF DESCRIPTION OF THE DRAWINGS

In the description of the invention, reference is made to the accompanying drawings, which are provided by way of non-limiting example, in which:

FIG. 1 diagrammatically shows a sectional view of some components of an extrusion press according to the invention;

FIG. 2 shows a perspective sectional view of part of an extrusion press according to the invention;

FIG. 3 shows a sectional view of part of an extrusion press according to the invention;

FIG. 4 shows a perspective view of a component of an extrusion press according to the invention.

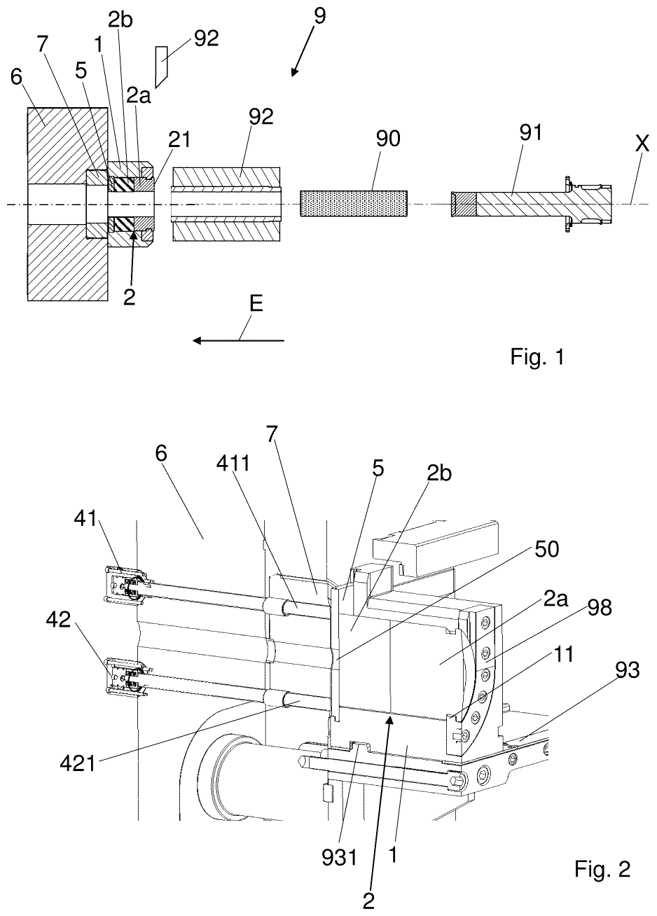

The same elements or functionally equivalent elements have the same reference numerals.

### DETAILED DESCRIPTION OF EXEMPLARY EMBODIMENTS OF THE INVENTION

With reference to the drawings, exemplary, non-limiting embodiments of an extrusion press 9 for producing a metal extrudate, in particular made of aluminum or aluminum alloy, by extruding a billet 90 along an extrusion axis X in an extrusion direction E, are described.

In all the embodiments, the extrusion press 9 comprises:
a die holder cassette 1 (or die carrier);
a die stack 2 accommodated or arranged at least partially in the die holder cassette 1, in particular wherein the die stack 2 comprises an extrusion die 2a;
thrust means 41, 42 adapted to move, in particular translate, the die stack 2 parallel to the extrusion axis X in direction opposite to the extrusion direction E;
a body 5 arranged between the thrust means 41, 42 and the die stack 2, provided with a through hole 50 which allows the passage of the metal extrudate through it;
a crosspiece 6, or extrusion crosspiece, arranged downstream of the die stack 2 with respect to the extrusion direction E;
a pressure ring 7 accommodated at least partially in crosspiece 6, in particular adapted to distribute the extrusion force to crosspiece 6;
   wherein said body 5 is distinct from the pressure ring 7;
   wherein said body 5 and the die stack 2 are adapted to translate along the extrusion axis X with respect to the die holder cassette 1;
   wherein the thrust means 41, 42 are adapted to push said body 5 to translate it, in particular parallel to the extrusion axis X, in said direction opposite to the extrusion direction E, and said body 5 is adapted to push the die stack 2, transmitting a translation motion imparted by the thrust means 41, 42 to the die stack 2 to translate the die stack 2 parallel to the extrusion axis X in said direction opposite to the extrusion direction E.

Body 5 in particular is a distinct component from the die stack 2. Therefore, advantageously the die stack 2 (which in particular comprises the extrusion die 2a and one or more bolsters 2b) may be replaced while leaving said body 5 mounted in the extrusion press 9.

The die stack 2 in particular comprises the extrusion die 2a and one or more bolsters 2b, and said body 5 is arranged between the thrust means 41, 42 and said one or more bolsters 2b. In particular, said body 5 is arranged between the thrust means 41, 42 and all the bolsters 2b of the die stack 2, which preferably are all the bolsters with which press 9 is provided.

Body 5 in particular faces one bolster 2b of said one or more bolsters. In particular, body 5 is adapted to come into contact with a bolster 2b of the die stack 2 to push the die stack 2 (and therefore also die 2a). More in detail, to push the die stack 2, said body 5 is adapted to come into contact with the bolster 2b of said one or more bolsters which is distal from the die 2a.

Body 5 is adapted to push the die stack 2 (i.e., it is adapted to push the one or more bolsters 2b and the die 2a). Body 5 in particular is intended to be replaced less frequently with respect to the die stack 2.

The one or more bolsters 2b serve, i.e., they are adapted, to support the extrusion load (or extrusion force) transmitted by the extrusion die 2a, in particular during the extrusion of billet 90.

In the example illustrated, one bolster 2b is provided, although more than one bolster 2b may be provided as mentioned above. The one or more bolsters 2b are downstream of the die 2a with respect to the extrusion direction E. Die 2a preferably is in contact with bolster 2b. In the case where more than one bolster is provided, one of the bolsters is preferably in contact with the die 2a, and the bolsters are in contact with one another. Each of the one or more bolsters 2b preferably is substantially a cylindrical body provided with a through hole, the latter having greater dimensions with respect to the through hole of die 2a.

Body 5 in particular is a distinct body from each of said one or more bolsters 2b. The extrusion press 9 is in particular configured so that when said thrust means 41, 42 move said body 5 parallel to the extrusion axis X in direction opposite to the extrusion direction E, said body 5 moves, in particular translates, with respect to the pressure ring 7 parallel to the extrusion axis X in direction opposite to the extrusion direction E.

Press 9 is provided with at least one abutment surface 11 adapted to act as stroke end for the translation of the die stack 2 when it is moved by the thrust means 41, 42 and by said body 5. The abutment surface 11 in particular is fixed in position.

Preferably, said abutment surface 11 is in the die holder cassette 1. In particular, the abutment surface 11 is inside the die holder cassette 1, more particularly in the space where also the die stack 2 is arranged.

Preferably, the die stack 2, in particular the die 2a, is adapted to abut with said abutment surface 11.

Preferably, said abutment surface 11 extends at least partially around said extrusion axis X.

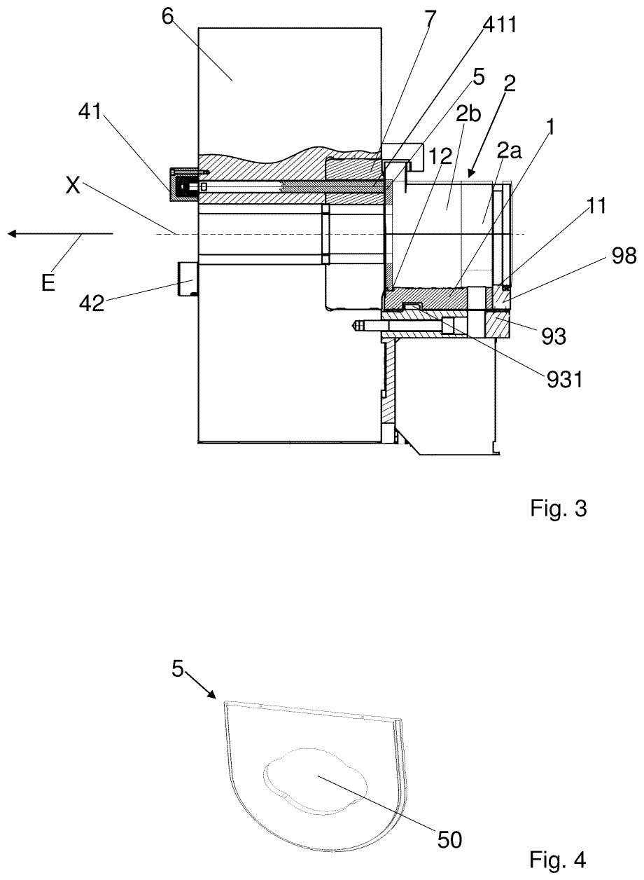

The abutment surface 11 may, by way of example and not by way of limitation, be formed by a protrusion of the inner surface of the die holder cassette 1, or may be formed by a protrusion of another component fastened to the die holder cassette 1 (for example, the component indicated by numeral 98 in FIGS. 2 and 3), or may be formed by another component of the press. For example, the abutment surface 11 may be formed by a protrusion of the component referred to as bracket 93.

Preferably, the maximum stroke of the die stack 2 inside the die holder cassette 1 is from 1 to 5 mm.

Body 5 is preferably arranged upstream, with respect to the extrusion direction E, of the pressure ring 7.

Preferably, said body 5 is accommodated at least partially in the die holder cassette 1 (as in the example shown). For example, body 5 may be accommodated in the die holder cassette 1 completely, or only in part. This positioning of body 5 makes the replacement and maintenance thereof particularly easy. Alternatively, body 5 may be outside the die holder cassette 1. For example, body 5 may be accommodated at least partially in the pressure ring 7. In this case, in particular, body 5 may be accommodated in a groove of the pressure ring 7, in particular so that body 5 is constrained to the pressure ring 7 and may in any case slide with respect to it, in particular under the effect of the thrust means 41, 42.

Body 5 is also called thrust body.

Body 5 is in particular arranged downstream, with respect to the extrusion direction E, of the extrusion die 2a.

Preferably, body 5 is made of steel.

Body 5 may, for example, be substantially a plate, in particular a plate provided with a through hole 50. Body 5 in particular has a thinner thickness with respect to the thickness of each of said one or more bolsters 2b, said thicknesses being in particular measured along the extrusion axis X when body 5 and the one or more bolsters 2b are mounted in press 9. Preferably, body 5 has a thickness from 20 to 70 mm, said thickness being in particular measured along the extrusion axis X when body 5 is mounted in press 9.

Body 5 may, for example, be an annular or substantially annular body.

The through hole 50 of body 5 is in particular crossed by the extrusion axis X.

The through hole 50 of body 5 preferably has greater dimensions with respect to the through hole of each of said one or more bolsters.

Preferably, body 5 and the pressure ring 7 face each other, in particular directly face each other, more specifically, are adapted to come into contact with each other.

Preferably, in all the embodiments at least part of the periphery of said body 5 is arranged in a groove 12 of the inner surface of the die holder cassette 1, in particular so that the body 5 is constrained to the die holder cassette 1 and may in any case slide with respect to it, in particular under the effect of the thrust means 41, 42. In particular, the groove 12 has a length along the extrusion axis X which is greater than, in particular slightly greater than, the thickness of body 5 along the extrusion axis X, in particular so that there is a clearance between the body 5 and the die holder cassette 1.

The groove 12, in particular, extends at least partially around the extrusion axis X.

Said thrust means 41, 42 comprise, or are, for example, a plurality of cylinder-piston systems 41, 42. For example, three or four cylinder-piston systems 41, 42 may be provided.

Preferably, each piston 411, 421 of a respective cylinder-piston system 41, 42 is in contact with, or adapted to come into contact with body 5. In particular, preferably each piston 411, 421 may come directly into contact with body 5.

The pistons 411, 421 of each cylinder-piston 41, 42 extend parallel to said extrusion axis X and cross the pressure ring 7, in particular so that each piston 411, 421 may push said body 5, more particularly so that each piston 411, 421 may come into contact with said body 5 to push it. In particular, each piston 411, 421 crosses a respective hole of the pressure ring 7.

For example, the end of each piston 411, 421 which is distal from the respective cylinder may come out of the pressure ring 7 to push body 5.

Advantageously, the pistons 411, 421 may translate through the pressure ring 7 to move body 5 (which in turn moves the die stack 2), and the sliding of the pistons 411, 421 does not induce the movement of the pressure ring 7. Therefore, when the thrust means 41, 42 push body 5, the pressure ring 7 advantageously remains fixed in position.

The extrusion press 9 preferably comprises cutting means 92 adapted to remove any residues of material from the die stack 2, in particular billet residues 90, deriving from the extrusion process. The cutting means 92 may belong to the extrusion press 9 or to an extrusion apparatus comprising the extrusion press 9.

The cutting means 92 are in particular arranged upstream of the die stack 2 with respect to the extrusion direction E.

The cutting means 92 comprise, or are, a shear provided with a sliding blade. The blade is in particular adapted to slide orthogonally to the extrusion axis X. The blade in particular is adapted to slide to remove residues of material from face 21 of the die stack 2 which is distal from the extrusion crosspiece 6.

Advantageously, the extrusion press 9 allows cutting means 92 to be used which position along the extrusion axis X remains fixed.

An extrusion press 9 according to the invention further comprises a punch 91 adapted to translate along the extrusion axis X to push billet 90 along the extrusion axis X in the extrusion direction E through the die stack 2, in particular through the extrusion die 2a.

Upstream of the die stack 2, press 9 preferably comprises a container 92 adapted to at least partially contain billet 90 during the extrusion.

The die holder cassette 1 is preferably arranged on a bracket 93. Preferably, also the die holder cassette 1 is adapted to translate parallel to the extrusion axis X. Bracket 93 is adapted to guide the sliding of the die holder cassette 1 when it translates parallel to the extrusion axis X. Bracket 93 is preferably provided with an abutment surface 931 adapted to serve as stroke end for the translation of the die holder cassette 1 when it translates parallel to the extrusion axis X in said direction opposite to the extrusion direction E.

In particular, preferably when the die stack 2 is pushed by the thrust means 41, 42 and abuts with the abutment surface 11, the die stack 2 drags the die holder cassette 1 up to bringing it to abut against the abutment surface 931 of bracket 93.

The invention also relates to a method for removing from the die stack 2 of an extrusion press 9, any residues of material generated by an extrusion process executed by means of said extrusion press 9, wherein there are provided the following steps:
a) pushing said body 5 by means of the thrust means 41, 42 to translate it, in particular parallel to the extrusion axis X in said direction opposite to the extrusion direction E, so that said body 5 pushes the die stack 2 (in particular, die 2a and all the bolsters 2b of the die stack 2), transmitting the translation motion imparted by the thrust means 41, 42 to the die stack 2, translating the die stack 2 parallel to the extrusion axis X in said direction opposite to the extrusion direction E, in particular up to bringing the die stack 2 to abut with the abutment surface 11 which is preferably in the die holder cassette 1;
b) removing said material residues by means of cutting means 92.

In particular, during step a), said body 5 moves with respect to the pressure ring 7.

Advantageously, during step a), the pressure ring 7 remains fixed in position. Advantageously furthermore during step a), the position along the extrusion axis X of the cutting means 92 remains fixed.

### In the Claims

1. An extrusion press (9) for producing a metal extrudate by extruding a billet (90) along an extrusion axis (X) in an extrusion direction (E), the extrusion press (9) comprising
a die holder cassette (1);
a die stack (2) accommodated at least partially in the die holder cassette (1), in particular wherein the die stack (2) comprises an extrusion die (2a);
thrust means (41, 42) adapted to move the die stack (2) parallel to the extrusion axis (X) in direction opposite to the extrusion direction (E);
a body (5) arranged between the thrust means (41, 42) and the die stack (2), provided with a through hole (50) which allows the passage of the metal extrudate through it;
a crosspiece (6) arranged downstream of the die stack (2);
a pressure ring (7) accommodated at least partially in the crosspiece (6);
wherein said body (5) is distinct from the pressure ring (7);
wherein said body (5) and the die stack (2) are adapted to translate along the extrusion axis (X) with respect to the die holder cassette (1);
wherein the thrust means (41, 42) are adapted to push said body (5) to translate it, and said body (5) is adapted to push the die stack (2), transmitting the translation motion imparted by the thrust means (41, 42) to the die stack (2) to translate it parallel to the extrusion axis (X) in said direction opposite to the extrusion direction (E).

2. An extrusion press (9) according to claim 1, wherein the die stack (2) comprises the extrusion die (2a) and one or more bolsters (2b), and wherein said body (5) is arranged between the thrust means (41, 42) and said one or more bolsters (2b); in particular, wherein said one or more bolsters (2b) are adapted to support the extrusion load transmitted by the extrusion die (2a).

3. An extrusion press (9) according to claim 2, wherein said body (5) is adapted to come into contact with the bolster (2b) of said one or more bolsters that is distal from the extrusion die (2a), in particular to push the die stack (2).

4. An extrusion press (9) according to any one of the preceding claims, wherein said body (5) is distinct from the die stack (2), in particular whereby the die stack (2) may be replaced, leaving said body (5) mounted in the extrusion press (9).

5. An extrusion press (9) according to any one of the preceding claims, wherein said body (5) has a thinner thickness with respect to the thickness of each of said one or more bolsters (2b).

6. An extrusion press (9) according to any one of the preceding claims, wherein said body (5) is accommodated at least partially in the die holder cassette (1).

7. An extrusion press (9) according to any one of the preceding claims, wherein at least part of the periphery of said body (5) is arranged in a groove (12) of the inner surface of the die holder cassette (1).

8. An extrusion press (9) according to any one of the preceding claims, wherein said body (5) is accommodated at least partially in the pressure ring (7).

9. An extrusion press (9) according to any one of the preceding claims, configured so that when said thrust means (41, 42) move said body (5), said body (5) moves, in particular moves away, from the pressure ring (7).

10. An extrusion press (9) according to any one of the preceding claims, wherein said thrust means (41, 42) comprise a plurality of pistons (411, 421) extending parallel to said extrusion axis (X) and crossing the pressure ring (7), in particular so that each piston (411, 421) can push said body (5), preferably coming into contact with said body (5).

11. An extrusion press (9) according to any one of the preceding claims, wherein said body (5) and said pressure ring (7) face each other.

12. An extrusion press (9) according to any one of the preceding claims, wherein there is provided at least one abutment surface (11) adapted to serve as stroke end for the translation of the die stack (2) when it is moved by the thrust means (41, 42) and by said body (5); in particular, wherein the die stack (2) is adapted to abut against said abutment surface (11); preferably wherein said abutment surface (11) at least partially extends around said extrusion axis (X) and/or said abutment surface (11) is in the die holder cassette (1).

13. An extrusion press (9) according to any one of the preceding claims, or extrusion apparatus comprising an extrusion press (9) according to any one of the preceding claims, the extrusion press (9) or the extrusion apparatus comprising cutting means (92), in particular arranged upstream of the die stack (2), adapted to remove from the die stack (2) any residues of material generated by the extrusion process.

14. A method for removing from the die stack (2) of an extrusion press (9) according to any one of the preceding claims, any residues of material generated by an extrusion process executed by means of said extrusion press (9),
wherein there are provided the following steps:
a) pushing said body (5), by means of the thrust means (41, 42), to translate it so that said body (5) pushes the die stack (2), transmitting the translation motion imparted by the thrust means (41, 42) to the die stack (2), translating it parallel to the extrusion axis (X) in said direction opposite to the extrusion direction (E), in particular up to bringing the die stack (2) to abut with an abutment surface (11) which is preferably in the die holder cassette (1);
b) removing said material residues by means of cutting means (92).

15. A method according to claim 14, wherein during step a), said body (5) moves with respect to the pressure ring (7), preferably wherein during step a), the pressure ring (7) remains fixed in position.

1. An extrusion press for producing a metal extrudate by extruding a billet along an extrusion axis in an extrusion direction, the extrusion press comprising:
a die holder cassette;
a die stack accommodated at least partially in the die holder cassette, in particular wherein the die stack comprises an extrusion die;
thrust means adapted to move the die stack parallel to the extrusion axis in direction opposite to the extrusion direction;
a body arranged between the thrust means and the die stack, provided with a through hole which allows the passage of the metal extrudate through it;
a crosspiece arranged downstream of the die stack
a pressure ring accommodated at least partially in the crosspiece (6);
wherein said body is distinct from the pressure ring;
wherein said body and the die stack are adapted to translate along the extrusion axis with respect to the die holder cassette;
wherein the thrust means are adapted to push said body to translate it, and said body is adapted to push the die stack transmitting the translation motion imparted by the thrust means to the die stack to translate it parallel to the extrusion axis (X) in said direction opposite to the extrusion direction.

2. The extrusion press according to claim 1, wherein the die stack comprises the extrusion die and one or more bolsters, and wherein said body is arranged between the thrust means and said one or more bolsters; in particular, wherein said one or more bolsters are adapted to support the extrusion load transmitted by the extrusion die.

3. The extrusion press according to claim 2, wherein said body is adapted to come into contact with the bolster of said one or more bolsters that is distal from the extrusion die, in particular to push the die stack.

4. The extrusion press according to claim 1, wherein said body is distinct from the die stack, in particular whereby the die stack may be replaced, leaving said body mounted in the extrusion press.

5. The extrusion press according to claim 1, wherein said body has a thinner thickness with respect to the thickness of each of said one or more bolsters.

6. The extrusion press according to claim 1, wherein said body is accommodated at least partially in the die holder cassette.

7. An The extrusion press according to claim 1, wherein at least part of the periphery of said body is arranged in a groove of the inner surface of the die holder cassette.

8. The extrusion press according to claim 1, wherein said body is accommodated at least partially in the pressure ring.

9. The extrusion press according to claim 1, configured so that when said thrust means move said body, said body moves, in particular moves away, from the pressure ring.

10. The extrusion press according to claim 1, wherein said thrust means comprise a plurality of pistons extending parallel to said extrusion axis and crossing the pressure ring, in particular so that each piston can push said body, preferably coming into contact with said body.

11. The extrusion press according to claim 1, wherein said body and said pressure ring face each other.

12. The extrusion press according to claim 1, wherein there is provided at least one abutment surface adapted to serve as stroke end for the translation of the die stack when it is moved by the thrust means and by said body; in particular, wherein the die stack is adapted to abut against said abutment surface; preferably wherein said abutment surface at least partially extends around said extrusion axis and/or said abutment surface is in the die holder cassette.

13. The extrusion press according to claim 1, or extrusion apparatus comprising an extrusion press according to any one of the preceding claims, the extrusion press or the extrusion apparatus comprising cutting means, in particular arranged upstream of the die stack, adapted to remove from the die stack any residues of material generated by the extrusion process.

14. A method for removing from the die stack of an extrusion press according to claim 1, any residues of material generated by an extrusion process executed by means of said extrusion press, wherein there are provided the following steps:
a) pushing said body, by means of the thrust means, to translate it so that said body pushes the die stack, transmitting the translation motion imparted by the thrust means to the die stack, translating it parallel to the extrusion axis in said direction opposite to the extrusion direction, in particular up to bringing the die stack to abut with an abutment surface which is preferably in the die holder cassette;
b) removing said material residues by means of cutting means

15. A The method according to claim 14, wherein during step a), said body moves with respect to the pressure ring, preferably wherein during step a), the pressure ring remains fixed in position.
